(19) United States
(12) Patent Application Publication
(10) Pub. No.: US 2018/0060786 A1
(43) Pub. Date: Mar. 1, 2018

(54) System and Method for Allocating Tickets

(71) Applicant: Wipro Limited, Bangalore (IN)

(72) Inventor: Arthi VENKATARAMAN, Bangalore (IN)

(73) Assignee: Wipro Limited

(21) Appl. No.: 15/297,181

(22) Filed: Oct. 19, 2016

(30) Foreign Application Priority Data
Aug. 30, 2016 (IN) 201641029589

(51) Int. Cl. G06Q 10/06; G06Q 30/00

(52) U.S. Cl. CPC G06Q 10/063112; G06Q 30/016; G06Q 10/063114

(57) ABSTRACT

Systems and methods for allocating tickets are described. When ticket is received, system looks for suitable agents for allocating the ticket. The system computes plurality of agents scores corresponding to plurality of agents. Based on the agent-scores, first-set of agents are identified. System further identifies second-set of agents from the first-set of agents based on some dynamic parameters like physical and emotional state of the agents, and further, ranks the second-set of agents. Now system makes an attempt to allocate the ticket to first best agent having highest rank. If the first best agent is available, system allocates the ticket. However, if the first best agent is unavailable, system looks for next best agent. If again the next best agent is unavailable, the system re-allocates current active ticket being handled by the next best agent to another next best agent and allocates the ticket to the next best agent.

### TECHNICAL FIELD

The present disclosure relates in general to resource allocation. More particularly, but not exclusively, the present disclosure discloses a method and system for dynamically allocating and reallocating of tickets.

### BACKGROUND

Allocation of problem tickets is known from a long time. In this process, when a request (e.g., service request) is received from a customer, a ticketing system automatically generates a ticket corresponding to that request. Now the next task is to allocate the ticket to a human agent also called as an operator or an agent. One approach of a(locating the tickets is a manual allocation. According to this approach, a supervisor allocates the incoming tickets to an agent. The selection of the agent by the supervisor is generally based on supervisor's perception about that agent. Suppose the ticket raised is technical in nature, then the supervisor will allocate the ticket to an agent A whom he/she (supervisor) believes that this kind of ticket can be comfortably handled by the agent A. However, this perception cannot be correct every time when the ticket is allocated. Due to this, there are high chances of mismatch during the ticket allocation.

One of a possible reason for such mismatch could be that, although the agent may be good in solving the technical tickets, however, he/she may not have faced that type of particular ticket earlier which is currently allocated by the supervisor. In other words, the ticket allocated is totally new for him/her. This happens because all the technical tickets are not of a same type and at same difficulty and importance level, and hence, it's a challenge to realize the agent's ticket resolving experience before allocating the ticket. Such type of realization about the agent is no way possible when the tickets are allocated manually.

Apart from the realization issue, another challenge is to consider physical and emotional parameters, for example, stress level of the agents before allocating the tickets. Thus, if the aforesaid challenges are not addressed, it ultimately leads to the allocation of the ticket to a non-suitable agent. This type of non-suitable allocation not only affects the internal process of an organization, but it also leads to huge wastage of time and resources of the organization.

### SUMMARY

Disclosed herein is a method and system for allocating tickets. Once a ticket is received or generated, the next task is to allocate that ticket to a suitable agent. Out of number of agents, there may be only few agents who can perfectly handle that type of ticket based on their experiences and expertise. Thus, the allocation of the ticket depends on multiple factors from both perspectives i.e., from ticket's perspective and also from the agent's perspective. For example, if the ticket is of technical nature (ticket's perspective), then the system looks for those agents who are expert in resolving technical tickets (agent's perspective) based on their past experience and scores which is explained in detail in upcoming paragraphs of specification. Not only agent's experience, but the system also takes into consideration agent's physical and emotional level (agent's perspective) before allocating the ticket. The ability of considering the physical and emotional level of the agents indicates technical nature of present invention. That is because, the system observes the behavior (both physical and emotional) of the agents before allocating the tickets. Thus, the present invention provides a technical solution to a technical problem of non-consideration of physical and emotional parameters of the agents while allocating the tickets. Apart from considering the multiple factors, the system also re-allocates the tickets from one agent to another agent based on availability of the agents and priority of the tickets which is explained in detail in subsequent paragraphs of the specification.

Accordingly, the present disclosure relates to a method for allocating tickets. The method comprises the steps of receiving a request for resolving a ticket associated with a ticket-type of a plurality of ticket-types. The ticket-type indicates nature of the ticket. The method further comprises computing a plurality of agent-scores corresponding to a plurality of agents relevant for handling the plurality of ticket-types based on historical information associated with the plurality of agents. The historical information indicates prior ticket resolving experience of the plurality of agents. Further, the method comprises a step of identifying a first-set of agents from the plurality of agents based on the plurality of agent-scores. The first-set of agents indicates appropriate agents for resolving the ticket. The method further comprises the step of identifying a second-set of agents from the first-set of agents based on a set of dynamic parameters. The second-set of agents indicates dynamically appropriate agents for resolving the ticket. Further, the method comprises ranking the second-set of agents based on corresponding agent-scores of the plurality of agent-scores. The method further comprises a step of determining an availability of a first best agent, from the second-set of agents, having a highest rank based on the ranking for allocating the ticket. If the first best agent is available, the method comprises allocating the ticket to the first best agent. However, if the first best agent is not available, the method comprises a step of determining availability of a next best agent based on the ranking. The ticket is allocated to the next best agent when the next best agent is available. However, if the next best agent is unavailable, the method comprises a step of determining a ticket-type of a current active ticket being allocated to the next best agent. The method further comprises a step of re-allocating the current active ticket, based on comparison of a status of the current active ticket with a predefined threshold and an importance level of the current active ticket, to another next best agent after the next best agent based on the ranking, thereby releasing the next best agent from the current active ticket. The status indicates a remaining time in completion of the current active ticket. Further, the method comprises allocating the ticket to the next best agent.

Further, the present disclosure relates to a ticket allocation system for allocating tickets. The ticket allocation system comprises a processor and a memory communicatively coupled to the processor. The memory stores processor-executable instructions, which, on execution, causes the processor to perform one or more operations comprising receiving a request for resolving a ticket associated with a ticket-type of a plurality of ticket-types. The ticket-type indicates nature of the ticket. Further, the system computes a plurality of agent-scores corresponding to a plurality of agents relevant for handling the plurality of ticket-types based on historical information associated with the plurality of agents. The historical information indicates prior ticket resolving experience of the plurality of agents. Further, the system identifies a first-set of agents from the plurality of agents based on the plurality of agent-scores. The first-set of agents indicates appropriate agents for resolving the ticket. The system further identifies a second-set of agents from the first-set of agents based on a set of dynamic parameters. The second-set of agents indicates dynamically appropriate agents for resolving the ticket. The system further ranks the second-set of agents based on corresponding agent-scores of the plurality of agent-scores. Further, the system determines an availability of a first best agent, from the second-set of agents, having a highest rank based on the ranking for allocating the ticket. If the first best agent is available, the system allocates the ticket to the first best agent. However, if the first best agent is not available, the system determines an availability of a next best agent based on the ranking. The ticket is allocated to the next best agent when the next best agent is available. However, if the next best agent is unavailable, the system determines a ticket-type of a current active ticket being allocated to the next best agent. Further, the system re-allocates the current active ticket, based on comparison of a status of the current active ticket with a predefined threshold and an importance level of the current active ticket, to another next best agent after the next best agent based on the ranking, thereby releasing the next best agent from the current active ticket. The status indicates a remaining time in completion of the current active ticket. The system further allocates the ticket to the next best agent.

In another embodiment, a non-transitory computer-readable storage medium for allocating tickets is disclosed, which when executed by a computing device, cause the computing device to perform operations including receiving a request for resolving a ticket associated with a ticket-type of a plurality of ticket-types. The ticket-type indicates nature of the ticket. The operations further include computing a plurality of agent-scores corresponding to a plurality of agents relevant for handling the plurality of ticket-types based on historical information associated with the plurality of agents. The historical information indicates prior ticket resolving experience of the plurality of agents. Further, the operations include a step of identifying a first-set of agents from the plurality of agents based on the plurality of agent-scores. The first-set of agents indicates appropriate agents for resolving the ticket. The operations further include the step of identifying a second-set of agents from the first-set of agents based on a set of dynamic parameters. The second-set of agents indicates dynamically appropriate agents for resolving the ticket. Further, the operations include ranking the second-set of agents based on corresponding agent-scores of the plurality of agent-scores. The operations further include a step of determining an availability of a first best agent, from the second-set of agents, having a highest rank based on the ranking for allocating the ticket. If the first best agent is available, the operations include allocating the ticket to the first best agent. However, if the first best agent is not available, the operations include a step of determining availability of a next best agent based on the ranking. The ticket is allocated to the next best agent when the next best agent is available. However, if the next best agent is unavailable, the operations include a step of determining a ticket-type of a current active ticket being allocated to the next best agent. The operations further include a step of re-allocating the current active ticket, based on comparison of a status of the current active ticket with a predefined threshold and an importance level of the current active ticket, to another next best agent after the next best agent based on the ranking, thereby releasing the next best agent from the current active ticket. The status indicates a remaining time in completion of the current active ticket. Further, the operations include allocating the ticket to the next best agent

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating a ticket allocation system for allocating tickets in accordance with some embodiments of the present disclosure;

FIG. 2 shows a detailed block diagram illustrating the ticket allocation system in accordance with some embodiments of the present disclosure;

FIG. 3 shows a flowchart illustrating a method of allocating tickets in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method in other words, one or more elements in a system or apparatus proceeded by “comprises . . . a” does not, without more constraints, preclude the existence of other elements or additional elements in the system or method.

The present disclosure relates to a method and a ticket allocation system (alternatively also referred as “system”) for allocating the tickets. Although, the method for allocating the tickets is described in conjunction with a server, the said method can also be implemented in various computing systems/devices, other than the server. When a request for resolving a ticket is received, a ticket-type of that ticket is determined. The ticket-type indicates nature of the ticket, for example, whether the ticket is technical or non-technical in nature. There may be number of agents to whom the ticket could be allocated. However, before allocation, the system computes agent-scores corresponding to the number of agents based on historical information associated with the agents, wherein the historical information indicates prior ticket resolving experience of the agents. Based on the agent-scores, a first-set of agents are identified from the total number of agents. The system further identifies a second-set of agents amongst the first-set of agents based on dynamic parameters like physical and emotional strength of the agents. Now, the system selects an agent, from the second-set of agents, having highest agent-score for allocating the ticket.

However, there may be a possibility that the agent selected by the system is not available. In this scenario, the system checks the availability of next agent (having the second highest agent-score) for allocating the ticket. However, if the next agent is also not available, the system determines ticket-type of a current active ticket i.e., a ticket currently being handled by the next best agent. Post determining the ticket-type, the system compares status (i.e., remaining time in completion of the current active ticket) with a predefined threshold and also checks an importance level (explained in detail in subsequent paragraphs of specification) of the current active tickets. Based on the comparison and the importance level, the system re-allocates the current active ticket to another next agent after the next agent (having the second highest agent-score). In this manner, the next agent is released from his/her current active ticket and now the system allocates the ticket to the next agent.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

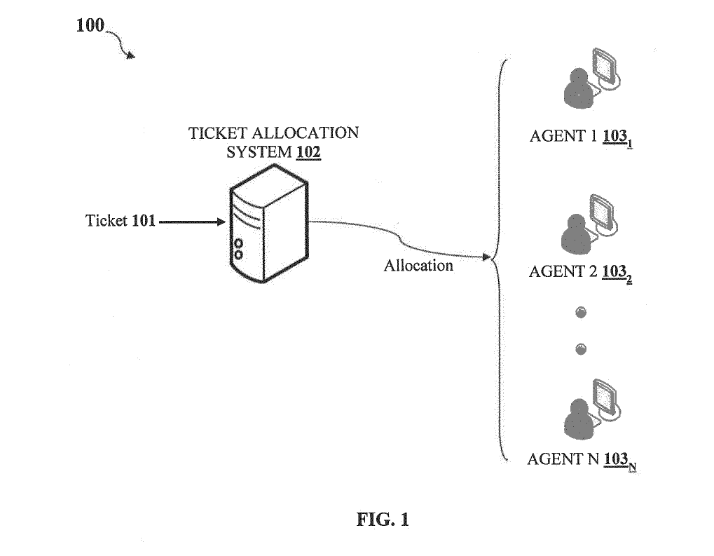

FIG. 1 shows an exemplary environment illustrating a ticket allocation system for allocating tickets.

The environment 100 comprises a ticket 101, the ticket allocation system 102 and a plurality of agents 103, agent 1 103₁ to agent N 103_{N} (collectively referred as plurality of agents 103). The ticket 101 may be a problem ticket raised based on service request of a customer/client. In an embodiment, the ticket 101 may be received from an external source, for example, ticket generating source. In an alternative embodiment, the ticket 101 may be generated by the system 102.

The ticket allocation system 102 receives the ticket 101 from an external source or generated by itself. The ticket 101 received may be associated with a certain ticket-type which indicates the nature of that ticket 101. For example, the ticket 101 may be a technical-type ticket, non-technical-type ticket, an administrative-type ticket or any other type of ticket raised during request/enquiry received from the customers/clients.

Post receiving the ticket 101, the ticket allocation system 102 determines a suitable agent amongst a plurality of agents 103 associated with the ticket allocation system 102. In an embodiment, the ticket allocation system 102 may include, but not limited to, a server, a computer, a workstation, a laptop, mobile phone, or any computing system/device capable of receiving, analysing and processing the useful information.

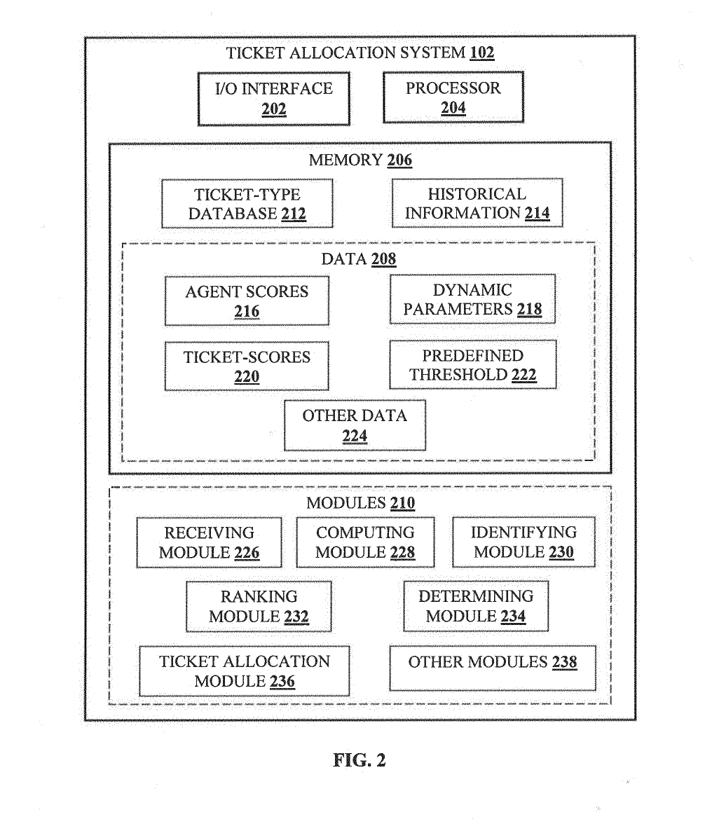

FIG. 2 shows a detailed block diagram illustrating the ticket allocation system in accordance with some embodiments of the present disclosure.

The ticket allocation system 102 comprises an I/O interface 202, a processor 204 and a memory 206. The I/O interface 202 is configured to receive one or more data, for example, a ticket from an external source. The memory 206 is communicatively coupled to the processor 204. The processor 204 is configured to perform one or more functions of the ticket allocation system 102 for allocating the ticket. In one implementation, the ticket allocation system 102 comprises data 208 and modules 210 for performing various operations in accordance with the embodiments of the present disclosure. The memory 206 further comprises a ticket-type database 212 and historical information 214. In an embodiment, the data 208 may include, without limitation, an agent-scores 216, dynamic parameters 218, ticket-scores 220, predefined threshold 222, and other data 224.

In one embodiment, the data 208 may be stored within the memory 208 in the form of various data structures. Additionally, the aforementioned data 208 can be organized using data models, such as relational or hierarchical data models. The other data 224 may store data, including temporary data and temporary files, generated by modules 210 for performing the various functions of the ticket allocation system 102.

In an embodiment, the ticket-type database 212 represents a plurality of ticket-types associated with the incoming tickets. The plurality of ticket-types may include, but not limited to, a technical-type ticket, a non-technical-type ticket and an administrative-type ticket. The ticket-type database 212 helps the system 102 in identifying the ticket-type of the ticket received for allocation. However, if the ticket received is of new type other than which are known to the ticket-type database 212, then the ticket-type database 212 automatically update its knowledge base with the new ticket-type identified.

In an embodiment, the historical information 214 is associated with the plurality of agents 103. The historical information 214 indicates prior ticket resolving experience of the plurality of agents 103. The historical information 214 is also updated based on experience of the agents.

In an embodiment, the data 208 may be processed by one or more modules 210. In one implementation, the one or more modules 210 may also be stored as a part of the processor 204. In an example, the one or more modules 210 may be communicatively coupled to the processor 204 for performing one or more functions of the ticket allocation system 102.

In one implementation, the one or more modules 210 may include, without limitation, a receiving module 226, a computing module 228, an identifying module 230, a ranking module 232, a determining module 234, a ticket allocation module 236, and other modules 238. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 226 receives a request for resolving a ticket. The ticket is associated with a particular ticket-type which indicates the nature of the received ticket. Before allocation of the ticket, it is important to understand the nature of the ticket in order to identify the suitable agent for that ticket. For example, if the ticket is of a technical nature, then the system 102 will look for those agents, amongst the plurality of agents 103, who are expert in resolving the technical type tickets. According to embodiments, there may be different type of ticket-types stored in ticket-type database 212 of the system 102. For example, the different ticket types may include a technical-type ticket, a non-technical-type ticket or an administrative-type ticket. For resolving the ticket, there may be plurality of agents 103 associated with the system 102 to whom the ticket could be allocated. However, the system 102 identifies a suitable agent amongst the plurality of agents 103 for allocating the ticket.

In an embodiment, the computing module 228 computes a plurality of agent-scores 216 corresponding to the plurality of agents 103 based on the historical information 214 associated with the plurality of agents 103. As discussed above, the historical information 214 indicates the prior ticket resolving experience of the plurality of agents 103. Thus, the plurality of agent-scores 216 computed helps the system 102 understand relevancy of the plurality of agents for handling the different ticket-types (technical, non-technical, administrative).

In the next step, the identifying module 230 identifies a first-set of agents from the plurality of agents 103 based on the plurality of agent-scores computed. The first-set of agents indicates appropriate agents or the suitable agents for resolving the ticket. Although, at this stage, the system 102 is successful in selecting the appropriate agents (i.e., first-set of agents) who are suitable for resolving the ticket, the next challenge is to understand the current physical and emotional parameters of the first-set of agents. At many occasions, it has been observed that a particular agent is one of a most appropriate agent for resolving the ticket, however, the current physical and emotional state of that agent may not allow him/her to resolve the ticket efficiently as expected.

Thus, to overcome this technical challenge, the identifying module 230 of the system 102 further drill-down and identifies a second-set of agents from the first-set of agents based on a set of dynamic parameters 218. These dynamic parameters 218 may include like tiredness levels, emotion, voice, and posture of the plurality of agents 103. While identification of the second-set of agents, the identifying module 230 may use different techniques like facial emotion detection, voice emotion detection, posture detection to determine the current alertness level of the agents, both physically and mentally. According to an embodiment, the system 102 may comprise dynamic parameter detection component (not shown in figure) which is capable of performing the abovementioned techniques i.e., facial emotion detection, voice emotion detection, and posture detection. The dynamic parameter detection component may comprise its own processor, application-specific integrated circuit (ASIC) chips, memory, image capturing units, and in-built classifiers for performing the above techniques. The image capturing unit captures the face as well as the different posture of the agents at regular interval. Further, the captured image data is transmitted to in-built machine learning models and in-built classifiers to classify the images as well as the posture. The detail working of the dynamic parameter detection component in conjunction of the system 102 is explained in below paragraphs.

While performing the “facial” emotion detection, the system 102 may score an agent based on multiple emotions. For example, on a scale of 0 to 1, the emotions are classified into positive and negative category. Emotions like anger, fear, disgust, sadness and in-difference are placed on the negative end of the scale, whereas, on the other hand, positive emotions like happiness and engagement place the score on the positive end of the scale.

Similarly, while performing the “voice” emotion detection, the system 102 may place the agent in the range of 0 and 1, wherein 1 indicates a positive state and 0 indicates negative state. For example, the voice emotion detection is performed using the in-built classifier based approach where voice samples are collected for both positive and negative cases for different score ranges. Thus, whenever a new voice data is received by the system 102, the in-built classifier classifies the voice data to check whether the emotion is positive or negative and also the level to which the voice data maps.

Similarly, the “posture” detection technique helps in tracking an agent's posture. The postures are also classified into positive and negative categories. For example, if the system 102 detects a straight upright posture of the agent, the system 102 will tag the agent in the positive category. The system 102 once again utilizes the in-built classifier based approach where samples are collected for positive and negative cases at different levels and a classifier model is built. The classifier model is built by taking postures, at regular intervals, of the live agents working on long running important tasks. Further, the postures are classified using this classifier model.

Based on the overall detection i.e., facial, voice, and posture, the system 102 arrives at the agent's overall engagement. This gives more clarity of the agent's current mental and physical state before allocating the ticket. Thus, the identified second-set of agents indicates dynamically appropriate agents for resolving the ticket. In this way, the system 102 identifies those agents who are not only the most appropriate ones based on their agent-scores, but also physically and mentally prepared for handling the ticket.

Now, once the second-set of agents are identified, the ranking module 232 of the system 102 ranks the second.-set of agents based on their corresponding agent-scores. Thus, based on the rank, the system 102 understands relevancy of each of the second-set of agents. Obviously, the second agent with the highest rank will be the most appropriate agent (or first best agent) to whom the system 102 will attempt to allocate the ticket. However, before such attempt, the system 102 determines the availability of that first best agent.

Thus, in next step, the determining module 234 determines the availability of that first best agent having the highest rank based on the ranking. The determining module 234 checks whether the first best agent is free or already engaged in resolving other tickets.

If the first best agent is available, the ticket allocation module 236 of the system 102 allocates the ticket to the first best agent. However, it may be possible that the first best agent may not be available for taking the ticket request. Thus, in this situation, ticket allocation module 236 looks for next best agent in the list and determines his/her availability. According to embodiments, the next best agent may be a second best agent based on the ranking. However, according to other embodiments, the next best agent may be any agent amongst the second-set of agents, other than the first best agent. Now, if the next best agent is available, the ticket allocation module 236 allocates the ticket to the next best agent. However, it may be again possible that the next best agent is also not available for taking the ticket request.

Now, here in this situation where one of a best agent (next best agent) is again unavailable, the system 102 performs re-allocation of tickets rather than looking for further best agents and again determining their availability. In this re-allocation process, at first, the ticket allocation module 236 identifies the current active ticket i.e., a ticket currently being handled by the next best agent. Now since the next best agent is already working on that current ticket, it is obvious that the current active ticket must have progressed to a certain stage. However, how far it has gone or how much time is still remaining in completion of the current active ticket is unknown.

For this, the ticket allocation module 23$ determines the status of that current active ticket i.e., the remaining time in completion of the current active ticket. Apart from the status, the ticket allocation module 236 also determines an importance level of the current active ticket. The importance level of the current active ticket or any ticket is determined by computing a ticket-score 220. According to embodiments of present disclosure, the ticket-score 220 is computed based on plurality of ticket parameters like priority level of ticket, impact level of ticket, and complexity level of ticket. For example, weights may be assigned to each of these parameters. Based on the weights, the ticket-scores 220 are computed. On a scale of 0 and 1, 0 indicates that the ticket is of least importance and 1 indicates that the ticket is of maximum importance.

Now, once the status and the importance level of the current active ticket is determined, the ticket allocation module 236 dynamically re-allocates the current active ticket to another next best agent after the next best agent based on comparison of the status with a predefined threshold 222 and importance level of the current active ticket. In other words, if it is determined that importance level of the current active ticket is less than the importance level of the ticket requested, and further, the remaining time in completion of that current active ticket is more than an hour (i.e., predefined threshold 222), then the ticket allocation module 236 dynamically re-allocates the current active ticket from the next best agent to the another next best agent. In this way, the next best agent is released from his/her current active ticket. Now, since the next best agent is released, the ticket allocation module 236 allocates the ticket to the next best agent. However, on the other hand, if during the comparison it is determined that the remaining time (status) in completion of that current active ticket is less than an hour (predefined threshold 222), then the ticket allocation module 236 do not perform any re-allocation.

Further, the re-allocation of tickets is also performed based on comparison of the set of dynamic parameters 218 associated with the agents. The ticket allocation module 236 monitors all the high priority tickets (i.e., having an importance level more than threshold) which are in progress. In any of the high priority tickets where the agents are continuously engaged for more than a set threshold of hours, the ticket allocation module 236 shortlist those agents. For all such tickets, the ticket allocation module 236 determines a dynamic parameter score based on the set of dynamic parameters 218. The dynamic parameter score indicates the physical and mental state of the agents. For example, on the scale of 0 and 1, it is determined that the agent having a dynamic parameter score as 0 is totally stressed out agent, whereas, the agent having a dynamic parameter score as 1 is a fresh or stress-free agent.

Further, the ticket allocation module 236 predicts the performance of those agents (i.e., under stressed agents) who are identified as under stress condition. Now, those under stressed agents whose performance is below a threshold will be automatically eliminated. In the next step, the best agent amongst the remaining under stressed agents will be selected. The ticket assigned to that best agent will be automatically re-assigned to some other agent. Now, the ticket allocation module 226 allocates other incoming ticket of high importance to that best agent. Thus, in this manner, the dynamic re-allocation of the ticket is performed from one agent to another agents based on their current physical and mental state.

To further elaborate the above explanation, few examples are explained below. However, before explaining the examples, following assumptions are taken:

Total Number of Agents—5 i.e., A, B, C, D and E

Total Number of Ticket-types—3 i.e., Ticket-type 1, Ticket-type 2, and Ticket-type 3

Further, below are capability/agent-scores of the agents corresponding to the different ticket-types;

Ticket-Type 1—Agent A (Score 0.9), Agent B (Score 0.7)

Ticket-Type 2.—Agent C (Score 0.9), Agent D (Score 0.8)

Ticket-Type 3—Agent E (Score 0.9), Agent A (Score 0.8)

Now assuming that currently Agent A, Agent B, and Agent D are busy or unavailable.

In example 1, suppose a high importance ticket X arrives with a ticket-type 3. Now, based on the agent-score (which indicates the prior ticket resolving experience), Agent E is the best agent and is also available. Further, based on the set of dynamic parameters 218 also, the Agent E is determined as the fit agent. Thus, in this example 1, the system 102 allocates the ticket X to the Agent E.

In example 2, suppose a high importance ticket X arrives with a ticket-type 3. Based on the agent-scores, Agent E and Agent A are the best agents. However, based on set of dynamic parameters 218, Agent E is found not suitable. Now, the system 102 checks the availability of the Agent A (who is the next best agent after Agent E). If it is determined that the Agent A is also not available because Agent A is already working on a low priority ticket Y of a ticket-type 1 in this situation, the system 102 re-assigns this low priority ticket Y to next available agent i.e., Agent C (since Agent B in already not available).

In example 3, suppose a high importance ticket X arrives with a ticket-type 3. Based on the agent-scores, Agent E and Agent A are the best agents for handling the ticket X. However, it is observed that Agent E is already working on some other high priority ticket P and Agent A is already working on some low priority ticket L. In this situation, the system 102 re-assigns the low priority ticket L to next available agent i.e., Agent C.

In example 4, dynamic re-allocation of the high priority ticket based on the set of dynamic parameters 218 is explained. Suppose Agent A is working on a high importance ticket X of ticket-type 1. However, based on the set of dynamic parameters 218, it is observed that Agent A is no longer suitable for this ticket X. Thus, now task is to re-allocate the ticket X to another good agent who is capable of handling the ticket X. In this situation, the system 102 identifies, based on agent-score and the set of dynamic parameters 218, that Agent B is suitable agent for handling the ticket A. Thus, the system 102 allocates the ticket X to the Agent B.

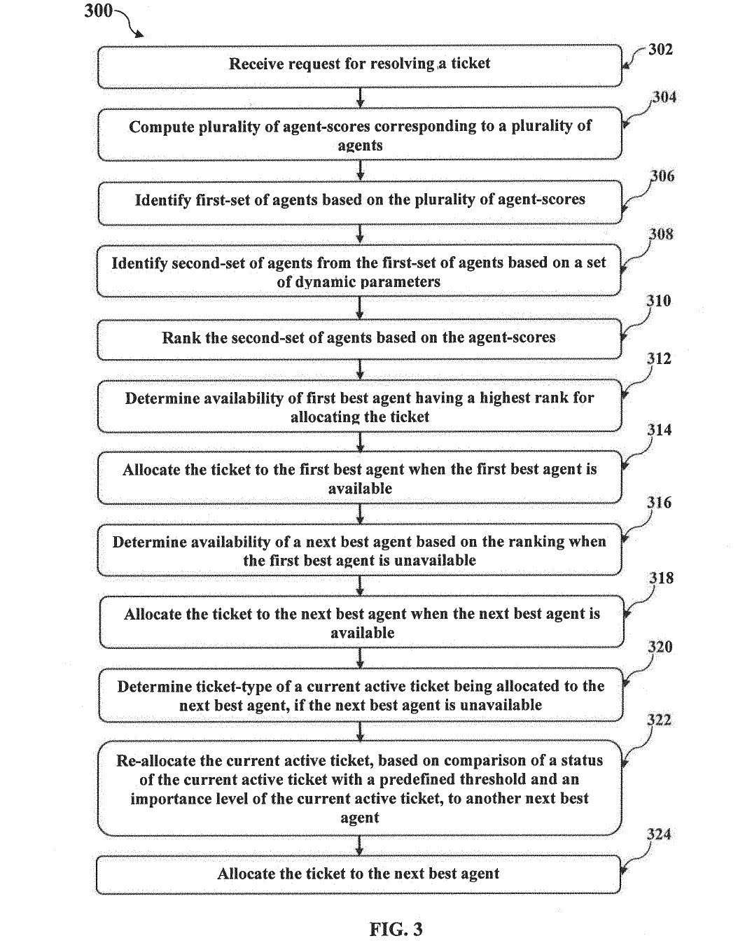

FIG. 3 shows a flowchart illustrating a method for allocating the tickets with some embodiments of the present disclosure.

As illustrated in FIG. 3, the method 300 comprises one or more blocks for allocating the tickets using a ticket allocation system 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 302, the ticket allocation system 102 receives a request for resolving a ticket associated with a ticket-type of a plurality of ticket-types. The ticket-type indicates nature of the ticket. Further, the ticket-type comprises at least one of technical-type ticket, non-technical-type ticket and administrative-type ticket.

At block 304, the ticket allocation system 102 computes a plurality of agent-scores corresponding to a plurality of agents relevant for handling the plurality of ticket-types based on historical information associated with the plurality of agents. The historical information indicates prior ticket resolving experience of the plurality of agents.

At block 306, the ticket allocation system 102 identifies a first-set of agents from the plurality of agents based on the plurality of agent-scores. The first-set of agents indicates appropriate agents for resolving the ticket.

At block 308, the ticket allocation system 102 identifies a second-set of agents from the first-set of agents based on a set of dynamic parameters 218. The second-set of agents indicates dynamically appropriate agents for resolving the ticket.

At block 310, the ticket allocation system 102 ranks the second-set of agents based on corresponding agent-scores of the plurality of agent-scores.

At block 312, the ticket allocation system 102 determines an availability of a first best agent, from the second-set of agents, having a highest rank based on the ranking for allocating the ticket.

At block 314, the ticket allocation system 102 allocates the ticket to the first best agent, when the first best agent is available.

At block 316, the ticket allocation system 102 determines an availability of a next best agent based on the ranking when the first best agent is unavailable.

At block 318, the ticket allocation system 102 allocates the ticket to the next best agent when the next best agent is available.

At block 320, the ticket allocation system 102 determines ticket-type of a current active ticket being allocated to the next best agent, if the next best agent is unavailable.

At block 322, the ticket allocation system 102 re-allocates the current active ticket, based on comparison of a status of the current active ticket with a predefined threshold 222 and an importance level of the current active ticket, to another next best agent after the next best agent based on the ranking. Thus, the next best agent is released from the current active ticket. Further, the status indicates a remaining time in completion of the current active ticket.

At block 324, the ticket allocation system 102 allocates the ticket to the next best agent.

### Computer System

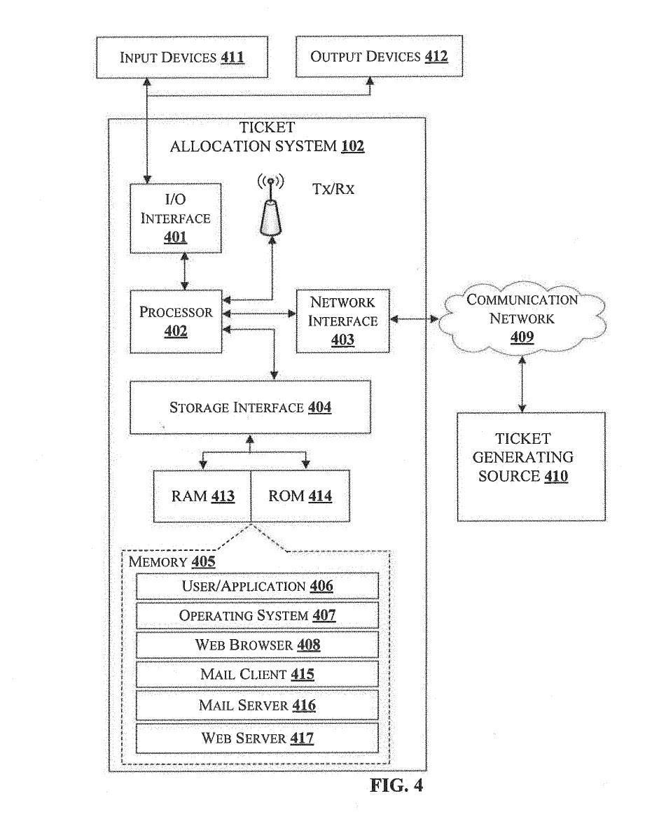

FIG. 4 illustrates a block diagram of an exemplary computer system 400 for implementing embodiments consistent with the present invention. In an embodiment, the computer system 400 can be the ticket allocation system 102 which is used for allocating the tickets. According to an embodiment, the computer system 400 may receive the ticket from a ticket generating source 410. However, according to other embodiment, the computer system 400 may generate the tickets internally. The computer system 400 may comprise a central processing unit (“CPU” or “processor”) 402. The processor 402 may comprise at least one data processor for executing program components for executing user- or system-generated business processes. The processor 402 may include, specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer stem 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11 a/b/g/n/x, etc. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example. Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (BATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web browser 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation. Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. I/O interface 401 may facilitate display, execution, interaction, manipulation, or operation of program components through textual or graphical facilities. For example, I/O interface may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory, Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for dynamically re-allocating the ticket based on detecting multiple factors in real-time like scores, dynamic parameters and availability.

In an embodiment, the method of present disclosure provides consideration of physical and emotional parameters of the agents before allocating the tickets.

In an embodiment, the present disclosure provides a method for dynamically allocating the tickets based on availability of the agents for handling the ticket.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single devices/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself,

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | ENVIRONMENT |
| 101 | TICKET |
| 102 | TICKET ALLOCATION SYSTEM |
| 103 | PLURALITY OF AGENTS |
| 202 | I/O INTERFACE |
| 204 | PROCESSOR |
| 206 | MEMORY |
| 208 | DATA |
| 210 | MODULES |
| 212 | TICKET-TYPE DATABASE |
| 214 | HISTORICAL INFORMATION |
| 216 | AGENT-SCORES |
| 218 | DYNAMIC PARAMETERS |
| 220 | TICKET-SCORES |
| 222 | PREDEFINED THRESHOLD |
| 224 | OTHER DATA |
| 226 | RECEIVING MODULE |
| 228 | COMPUTING MODULE |
| 230 | IDENTIFYING MODULE |
| 232 | RANKING MODULE |
| 234 | DETERMINING MODULE |
| 236 | TICKET ALLOCATION MODULE |
| 238 | OTHER MODULES |

Weclaim:

1. A method for allocating tickets, the method comprising:
receiving, by a ticket allocation system, a request for resolving a ticket associated with a ticket-type of a plurality of ticket-types, wherein the ticket-type indicates nature of the ticket;
computing, by the ticket allocation system, a plurality of agent-scores corresponding to a plurality of agents relevant for handling the plurality of ticket-types based on a historical information associated with the plurality of agents, wherein the historical information indicates prior ticket resolving experience of the plurality of agents;
identifying, by the ticket allocation system,
a first-set of agents from the plurality of agents based on the plurality of agent-scores, wherein the first-set of agents indicates appropriate agents for resolving the ticket, and
a second-set of agents from the first-set of agents based on a set of dynamic parameters, wherein the second-set of agents indicates dynamically appropriate agents for resolving the ticket;
ranking, by the ticket allocation system, the second-set of agents based on corresponding agent-scores of the plurality of agent-scores;
determining, by the ticket allocation system, an availability of a first best agent, from the second-set of agents, having a highest rank based on the ranking for allocating the ticket; and
performing, by the ticket allocation system, based on the availability of the first best agent, at least one of:
allocating the ticket to the first best agent, when the first best agent is available; or
determining an availability of a next best agent based on the ranking, when the first best agent is unavailable, wherein:
the ticket is allocated to the next best agent when the next best agent is available, and
if the next beat agent is unavailable,
determining a ticket-type of a current active ticket being allocated to the next best agent,
re-allocating the current active ticket, based on comparison of a status of the current active ticket with a predefined threshold and an importance level of the current active ticket, to another next best agent after the next best agent based on the ranking, thereby releasing the next best agent from the current active ticket, wherein the status indicates a remaining time in completion of the current active ticket, and
allocating the ticket to the next best agent.

2. The method as claimed in claim 1 further comprising re-allocating the ticket from a previously assigned agent to a new agent of the plurality of agents based on the set of dynamic parameters associated with the previously assigned agent.

3. The method as claimed in claim 1, wherein the plurality of ticket-types comprises at least one of technical-type ticket, non-technical-type ticket and administrative-type ticket.

4. The method as claimed in claim 1, wherein the set of dynamic parameters comprises at least one of tiredness levels, emotion, voice, or posture associated with the plurality of agents.

5. The method as claimed in claim 1, wherein the importance level of the current active ticket is determined by computing a ticket score.

6. The method as claimed in claim 5, wherein the ticket score is computed based on plurality of ticket parameters comprising at least one of priority level of the ticket, impact level of the ticket or complexity level of the ticket.

7. A ticket allocation system for allocating tickets, the system comprising:
a processor; and
a memory communicatively coupled to the processor, wherein the memory stores processor-executable instructions, which, on execution, causes the processor to:
receive a request for resolving a ticket associated with a ticket-type of a plurality of ticket-types, wherein the ticket-type indicates nature of the ticket;
compute a plurality of agent-scores corresponding to a plurality of agents relevant for handling the plurality of ticket-types based on a historical information associated with the plurality of agents, wherein the historical information indicates prior ticket resolving experience of the plurality of agents;
identify:
a first-set of agents from the plurality of agents based on the plurality of agent-scores, wherein the first-set of agents indicates appropriate agents for resolving the ticket, and
a second-set of agents from the first-set of agents based on a set of dynamic parameters, wherein the second-set of agents indicates dynamically appropriate agents for resolving the ticket;
rank the second-set of agents based on corresponding agent-scores of the plurality of agent-scores;
determine an availability of a first best agent, from the second-set of agents, having a highest rank based on the ranking for allocating the ticket; and
perform, based on the availability of the first best agent, at least one of:
allocating the ticket to the first best agent, when the first best agent is available; or
determining an availability of a next best agent based on the ranking, when the first best agent is unavailable, wherein:
the ticket is, allocated to the next best agent when the next best agent is available, and
if the next best agent is unavailable,
determining a ticket-type of a current active ticket being allocated to the next best agent,
re-allocating the current active ticket, based on comparison of a status of the current active ticket with a predefined threshold and an importance level of the current active ticket, to another next best agent after the next best agent based on the ranking, thereby releasing the next best agent from the current active ticket, wherein the status indicates a remaining time in completion of the current active ticket, and
allocating the ticket to the next best agent.

8. The ticket allocation system as claimed in claim 7, wherein the processor is further configured to re-allocate the ticket from a previously assigned agent to a new agent of the plurality of agents based on the set of dynamic parameters associated with the previously assigned agent.

9. The ticket allocation system as claimed in claim 7, wherein the plurality of ticket-types comprises at least one of technical-type ticket, non-technical-type ticket and administrative-type ticket.

10. The ticket allocation system as claimed in claim 7, wherein the set of dynamic parameters comprises at least one of tiredness levels, emotion, voice, or posture associated with the plurality of agents.

11. The ticket allocation system as claimed in claim 7, wherein the importance level of the current active ticket is determined by computing a ticket score.

12. The ticket allocation system as claimed in claim 11, wherein the ticket score is computed based on plurality of ticket parameters comprising at least one of priority level of the ticket, impact level of the ticket or complexity level of the ticket.

13. A non-transitory computer-readable medium storing instructions for allocating tickets, wherein upon execution of the instructions by one or more processors, the processors perform operations comprising:
receiving a request for resolving a ticket associated with a ticket-type of a plurality of ticket-types, wherein the ticket-type indicates nature of the ticket;
computing a plurality of agent-scores corresponding to a plurality of agents relevant for handling the plurality of ticket-types based on a historical information associated with the plurality of agents, wherein the historical information indicates prior ticket resolving experience of the plurality of agents;
identifying:
a first-set of agents from the plurality of agents based on the plurality of agent-scores, wherein the first-set of agents indicates appropriate agents for resolving the ticket, and
a second-set of agents from the first-set of agents based on a set of dynamic parameters, wherein the second-set of agents indicates dynamically appropriate agents for resolving the ticket;
ranking the second-set of agents based on corresponding agent-scores of the plurality of agent-scores;
determining an availability of a first best agent, from the second-set of agents, having a highest rank based on the ranking for allocating the ticket; and
performing, based on the availability of the first best agent, at least one of:
allocating the ticket to the first best agent, when the first best agent is available; or
determining an availability of a next best agent based on the ranking, when the first best agent is unavailable, wherein:
the ticket is allocated to the next best agent when the next best agent is available, and
if the next best agent is unavailable,
determining a ticket-type of a current active ticket being allocated to the next best agent;
re-allocating the current active ticket, based on comparison of a status of the current active ticket with a predefined threshold and an importance level of the current active ticket, to another next best agent after the next best agent based on the ranking, thereby releasing the next best agent from the current active ticket, wherein the status indicates a remaining time in completion of the current active ticket, and
allocating the ticket to the next best agent.

14. The medium as claimed in claim 13, further comprising re-allocating the ticket from a previously assigned agent to a new agent of the plurality of agents based on the set of dynamic parameters associated with the previously assigned agent.

15. The medium as claimed in claim 13, wherein the plurality of ticket-types comprises at least one of technical-type ticket, non-technical-type ticket and administrative-type ticket.

16. The medium as claimed in claim 13, wherein the set of dynamic parameters comprises at least one of tiredness levels, emotion, voice, or posture associated with the plurality of agents.

17. The medium as claimed in claim 13, wherein the importance level of the current active ticket is determined by computing a ticket score.

18. The medium as claimed in claim 17, wherein the ticket score is computed based on plurality of ticket parameters comprising at least one of priority level of the ticket, impact level of the ticket or complexity level of the ticket.
